(19) United States
(12) Patent Application Publication
(10) Pub. No.: US 2010/0075659 A1
(43) Pub. Date: Mar. 25, 2010

(54) METHOD FOR TRANSMITTING DATA IN EVOLVED UTMS NETWORK SYSTEM

(75) Inventors: Chang-Ki Kim, Daejon (KR); Young-Jick Bahg, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignees: Electronics and Telecommunications Research Institute, Daejeon (KR); Samsung Electronics Co., Ltd., Suwon-si, Gyeonggi-do (KR)

(21) Appl. No.: 12/443,390

(22) PCT Filed: Sep. 21, 2007
(86) PCT No.: PCT/KR07/04691

§ 371 Date: Mar. 27, 2009

(30) Foreign Application Priority Data
Sep. 29, 2006 (KR) 10-2006-0095815

(51) Int. Cl. H04W 4/00

(52) U.S. Cl. 455/422.1

(57) ABSTRACT

Provided is an apparatus and method for transmitting user data by using a logical tunnel in an evolved UMTS network system. The method includes the steps of: a) assigning a tunnel Identifier (ID); b) creating a tunnel management table according to the tunnel ID; c) receiving downlink user data; d) creating a down-link protocol message corresponding to the down-link user data based on the tunnel ID; and e) transmitting the down-link protocol message.

### TECHNICAL FIELD

The present invention relates to a method for transmitting data in an evolved Universal Mobile Telecommunication System (UMTS); and, more particularly, to a method for transmitting and managing user data in an evolved UMTS network system. This work was partly supported by the Information Technology (IT) research and development program of the Korean Ministry of Information and Communication (MIC) and/or the Korean Institute for Information Technology Advancement (IITA) [2005-S-404-22, “Research and development on 3G long-term evolution access system”].

### BACKGROUND ART

A Wideband Code Division Multiple Access (WCDMA) mobile communication system which is currently on service is commercialized reflecting R5 standard specification of the 3^{rd} Generation Partnership Project (3GPP). Therefore, the architecture of the current WCDMA access network comprises a user equipment (UE), a node B base station (NodeB), a Radio Network Controller (RNC), a Serving General Packet Radio Service (GPRS) Support Node (SGSN), which is a core network, and a Gateway GPRS Support Node (GGSN). Protocol and procedure for transmitting control messages and user data among the entities are defined in R5 standard specification.

Also, due to the drastic increase in traffic, standardization is underway to form a Long-Term Evaluation Network (LTE) and provide an Internet Protocol (IP)-based service in a mobile communication system for a low-speed packet service based the 3GPP standard specification. The 3GPP is working on standardization of evolved network technologies, such as Service Architecture Evolution (SAE), wireless interface, and access from a heterogeneous network to the 3GPP network for high data transmission rate, low latency, and a packet-optimized system.

The 3GPP is working on R7 standardization for the next-generation mobile communication access network, aiming at high data transmission rate, short latency, and access permission to diverse IP access networks to form the next-generation mobile communication network, which is the evolved UMTS network.

The R7 forms many physical functional entities of a conventional access network with a mobile node, which is a user equipment, an Evolved-UTRAN (E-UERAN), and an Evolved Packet Core (EPC) for high data transmission rate and short latency; and provides compatibility with existing R5-based networks for handoff through EPC and mobility with an IP-based Wireless Local Area Network (WLAN), which are described in detail in 3GPP TR23.882.

E-UTRAN includes a plurality of E-NodeB, and EPC includes an access gateway (aGW), a 3GPP anchor in charge of mobility between 3GPP networks, and an SAE anchor for mobility among heterogeneous networks.

The 3GPP defines requirements and logical functional entities therefor based on a service to be provided, and thus forms protocol among basic nodes. It also actively proceeds standardization discussion on a user equipment, an eNodeB and an access gateway.

The eNodeB of the E-UTRAN includes many functions of RNC accorded to R5. Particularly, the function of Medium Access Control (MAC) and Radio Link Control (RLC), which are L2 layer functions of RNC, and the Radio Resource Control (RRC) in charge of important control of L3.

The access gateway includes a Packet Data Convergence Protocol (PDCP) function in charge of user packet compression of R5 along with SGSN and GGSN functions of R5. Up to now 3GPP standard provides logical function entity according to physical node and function but the method for control and transmitting between eNodeB and aGW is not discussed, so, specific transmitting procedure standard is needed.

The method for transmitting user data among user plane entities (UPEs) of the eNodeB and the access gateway should be designed to satisfy high transmission rate and short latency, which are basic objects of the R7, to accurately transmit the user data of each subscriber to a corresponding eNodeB, to transmit the user data according to mobility among eNodeBs, and to have mobility and compatibility with a conventional R5 network.

### DISCLOSURE OF INVENTION

### Technical Problem

An embodiment of the present invention is directed to providing a method for transmitting data in an evolved UMTS network system.

Another embodiment of the present invention is directed to providing a protocol message format for transmitting user data by using a logical tunnel in an evolved Universal Mobile Telecommunication System (UMTS) network system.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for transmitting user data in mobile communication system, which includes the steps of: a) assigning a tunnel identifier (ID); b) creating a tunnel management table according to the tunnel ID; c) receiving downlink user data; d) creating a down-link protocol message corresponding to the down-link user data based on the tunnel ID; and e) transmitting the down-link protocol message.

In accordance with another aspect of the present invention, there is provided a method for transmitting user data in a mobile communication system, which includes the steps of: a) assigning a tunnel ID; b) creating a tunnel management table according to the tunnel ID; c) receiving up-link user data from a base station; d) creating an up-link protocol message corresponding to the up-link user data based on the tunnel ID; and e) transmitting the up-link protocol message.

In accordance with another aspect of the present invention, there is provided an apparatus for transmitting and receiving user data to and from a base station in a mobile communication system, wherein the apparatus includes a mobility management entity (MME) for managing and controlling mobility of a user equipment and a user plane entity (UPE) for transmitting user data, the apparatus which includes: a tunneling managing means for assigning a tunnel identifier (ID) corresponding to transmitted or received user data; and a base station interfacing means for transmitting and receiving a protocol message to and from the base station through a tunnel identified by the tunnel ID. Herein, the tunneling managing means and the base station interfacing means are disposed in the user plane entity.

The tunnel management table may include the tunnel ID, state information indicating a state of a tunnel, and base station address information indicating an address of the base station. Herein, the tunnel management table further includes a RABID mapped with the tunnel ID, a RBID mapped with the RABID, and service type information.

Also, the protocol message includes a header and a packet of the user data, and the header includes the tunnel ID, data packet type and the data length of payload.

The protocol message may further include a message unit identifier (MUI), and the protocol message further includes a confirmation request (CNF).

### ADVANTAGEOUS EFFECTS

The method of the present invention can transmit user data efficiently using logical tunnel in an evolved UMTS network system.

Also, the method of the present invention can facilitate user data transmitting management and increase the efficiency of the whole system by using a logical tunnel to transmit the user data between eNodeB and aGW efficiently in the evolved Universal Mobile Telecommunication System (UMTS) network.

In addition, the method of the present invention can increase encoding/decoding efficiency of the system and minimize data overhead in a transmission network by defining and using up-link and downlink message formats formed of the least amount of information elements that are needed essentially for the transmission of the user data, e.g., PDCP compressed data.

Further, a tunnel management table suggested in the present invention can systematically manage a process of transmitting the user data through a tunnel by managing diverse information including control information transmitted from a mobility management entity (MME) based on a generated tunnel ID, and it can easily extend tunnel management information by adding a field to the table.

### BRIEF DESCRIPTION OF THE DRAWINGS

FIG. 1 is a block of an evolved UMTS network system to which the present invention is applied.

FIG. 2 illustrates an access gateway (aGW) in accordance with an embodiment of the present invention.

FIG. 3 is an exemplary view describing control of an evolved Universal Mobile Telecommunication System (UMTS) network and a user plane protocol stack in accordance with an embodiment of the present invention.

FIG. 4 describes a tunnel management for user data transmission between eNodeB and UPE in accordance with an embodiment of the present invention.

FIG. 5 shows a tunnel management table in accordance with an embodiment of the present invention.

FIG. 6 illustrates a format of a protocol message for transmitting user data between eNodeB and UPE using the tunnel in accordance with an embodiment of the present invention.

FIG. 7 is a flowchart describing a process of user data transmission between eNodeB and UPE using the tunnel in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. When it is considered that detailed description on a related art may obscure the points of the present invention, the description will not be provided. Hereinafter, specific embodiments of the present invention will be described in detail with reference to the accompanying drawings.

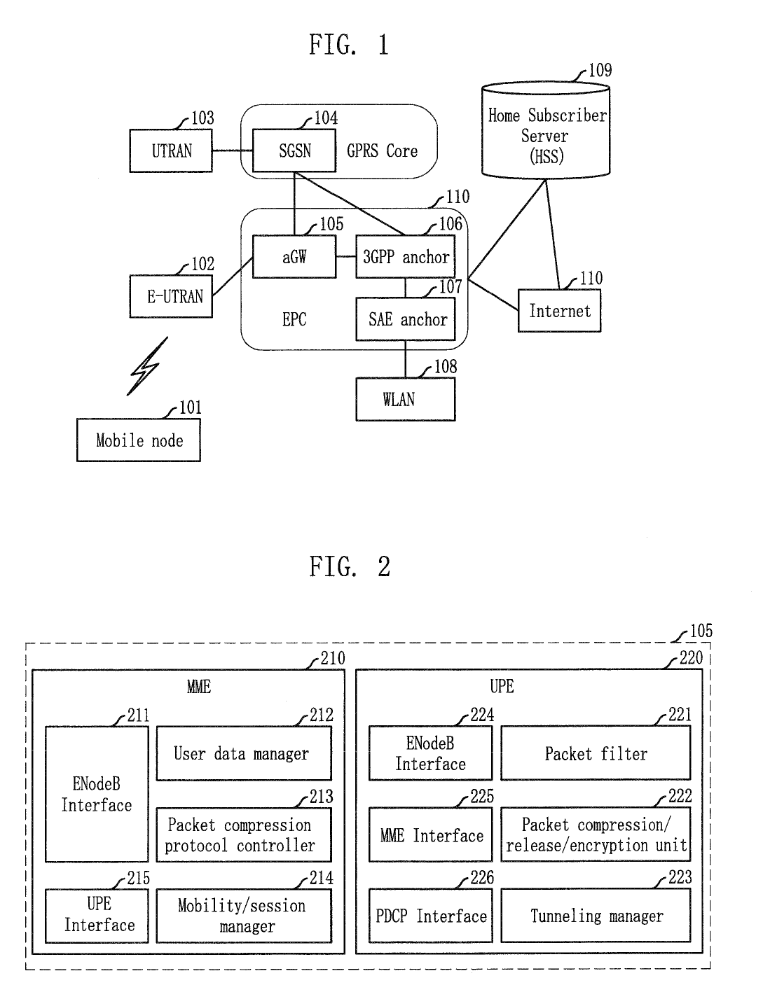

FIG. 1 is a block of an evolved Universal Mobile Telecommunication System (UMTS) network system to which the present invention is applied.

Referring to FIG. 1, the evolved UMTS network system includes a mobile node, which is a user equipment (UE) 101, an evolved radio access network 102, which is E-UTRAN, and an evolved packet core (EPC) 111. The evolved UMTS network system may be connected to a conventional access network 103, which is a UTRAN, through a Serving GPRS Support Node (SGSN) 104, or it may be connected to a non-3NPP IP-based access network 108, which is a Wireless Local Area Network (WLAN), a home subscriber server (HSS) 109, an Internet network 110, and an IP multimedia subsystem (IMS) (not shown).

The EPC 111 includes an access gateway (aGW) 105, a 3GPP anchor 106 and a SAE anchor 107.

The mobile node 101 is a user equipment that is capable of providing an IP multimedia service (for example, voice, image, positioning and an instant message service).

The UTRAN 103 includes a NodeB in charge of accessing to the mobile node and an RNC in the air according to conventional R5 standard.

The SGSN 104 is a packet exchange network, such as a Gateway GPRS Support Node (GGSN). It transmits traffic between the radio access network and an external network or an IP multimedia core network, and it is connected to the HSS 109 to process registration, certification, authorization of a subscriber. It is also connected to the EPC 110, the access gateway 105 and the 3GPP anchor 106 for the mobility in connection with the evolved UMTS network.

The access gateway 105 is connected to the eNodeB of the E-UTRAN 102 and it includes a control plane Mobile Management Entity (MME) in charge of managing subscriber mobility and the user plane entity (UPE) for transmitting user traffic data.

The MME is connected to the home subscriber server 109 for subscriber mobility management.

The user plane entity is only connected to a Internet network 110 to transmit the user data. When the user is a subscriber for IP multimedia contents, the user plane entity may be connected to the IP multimedia sub-network (IMS).

The 3GPP anchor 106 controls mobility between 3GPP networks.

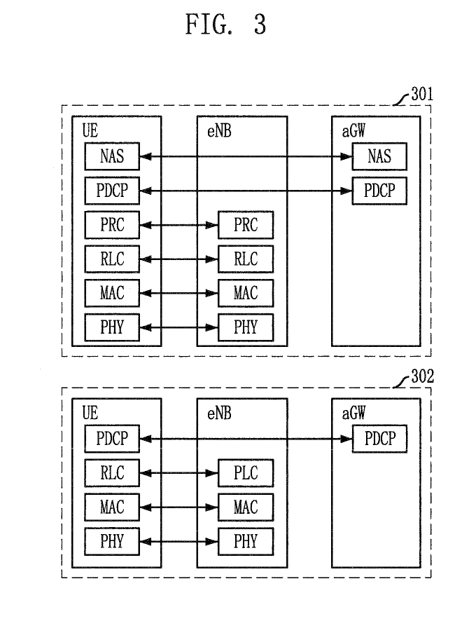

FIG. 2 illustrates an access gateway in accordance with an embodiment of the present invention.

Referring FIG. 2, the access gateway 105 includes a mobility management entity 210 for controlling and managing subscriber mobility and a UPE 220 for transmitting user data.

The mobility management entity 210 includes a mobility/session manager 214 for managing mobility and session of a subscriber, a packet compression protocol controller 213 for controlling Packet Data Convergence Protocol (PDCP) through communication with the user plane entity 220, a user data manager 212 for controlling a tunnel for transmitting user data, an eNodeB interface 211 for transmitting and receiving a control message with the eNodeB, and a user plane entity interface 215 for inputting and outputting data to and from the user plane entity.

The user plane entity 220 includes a packet filter 221 selecting packets heading for a user equipment in the eNodeB managed by the current access gateway among user data inputted from a external Internet network, a packet compression/release/encryption unit for compressing, releasing and encrypting IP packets for compression and security, a tunneling manager 223 for assigning a tunnel Identifier (ID) to transmit compressed user data to the eNodeB through the logical tunnel suggested in the present invention, creating and managing a tunnel management table according to the tunnel ID, and generating a protocol message based on the tunnel ID and the tunnel management table, an eNodeB interface 224 for transmitting and receiving the protocol message to and from the eNodeB, a mobility management entity interface 225 for transmitting and receiving data to and from a mobility management entity, and a PDCP interface 226 for transmitting and receiving data to and from a PDCP. The mobility management entity 210 and the user plane entity 220 communicate with the eNodeB through a UDP/IP based on an Ethernet.

FIG. 3 is an exemplary view describing control of an evolved UMTS network and a user plane protocol stack in accordance with an embodiment of the present invention.

Referring to FIG. 3, a protocol stack is divided into a control plane protocol stack 301 which is equivalent to the MME and a user plane protocol stack 302 which is equivalent to a user plane entity. With the respect of a protocol stack, the present invention relates to a technology for transmitting user data obtained passing through a PDCP layer of the access gateway in the user plane protocol stack 302 to the eNodeB.

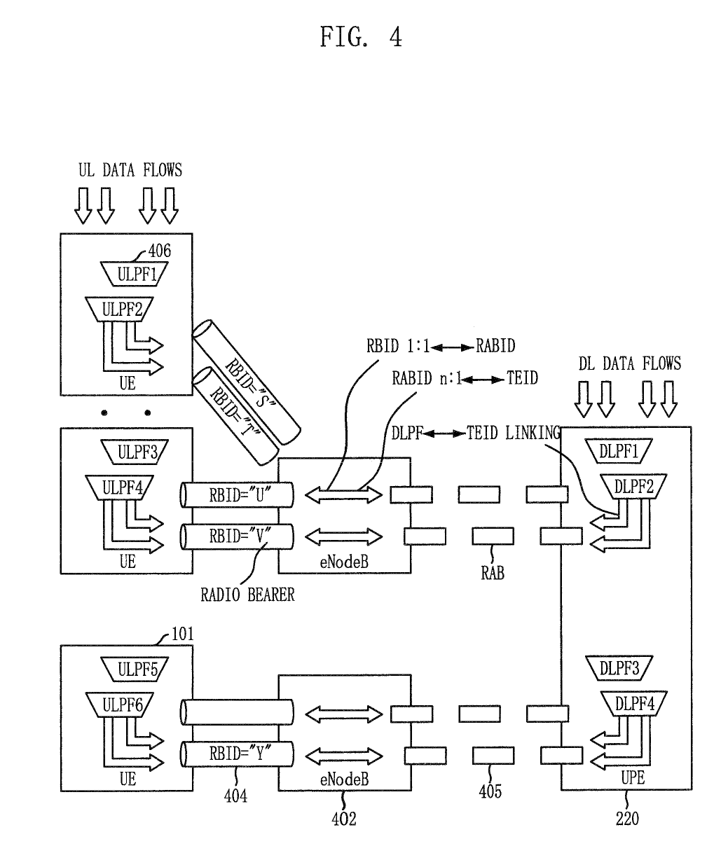

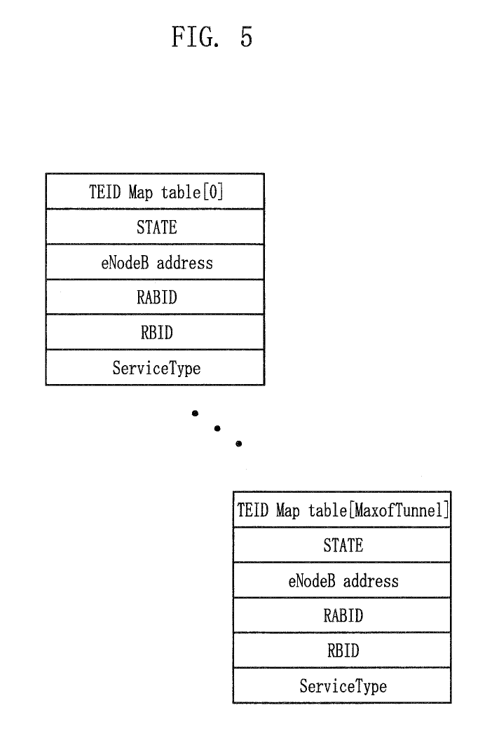

FIG. 4 describes a tunnel management for user data transmission between eNodeB and UPE in accordance with an embodiment of the present invention.

The UPE 220 may be connected to a plurality of eNodeB, which are also connected to a plurality of user equipments 101, individually.

The user equipment 101 transmits user data into the air through the eNodeB and a logical radio channel path identifier which is called a radio bearer identifier (RBID). For this, it includes an Up-Link Packet Filter (ULPF) for mapping the user data divided according to each service to a corresponding RBID.

The eNodeB 402 uses a Radio Access Bearer ID (RABID) corresponding to an RBID in one to one to transmitting and receiving data to and from the UPE 220. For this, the eNodeB 402 includes and manages a table for a relationship between the RABID and the RBID.

Substantial transmission of user data between the eNodeB 402 and the user plane entity 220 is executed through a logical tunnel suggested in the present invention, and the tunnel is managed using a Tunnel Endpoint Identifier (TEID).

This requires the eNodeB to have a tunnel management table, which shows the relationship between the RABID and the TEID, and the relationship between the RABID and the TEID is n to 1. In short, more than one RABID user data can be transmitted with one TEID.

The user plane entity 220 assigns the TEID in response to a tunnel creation request transmitted from the mobility management entity, and transmits and receives the user data to and from the eNodeB through the logical tunnel of the assigned TEID. Assigned TEID is transmitted to the eNodeB through the MME before transmission of the user data.

The tunneling manager 224 of the UPE 220 includes a tunnel management table, which includes TEID state information, eNodeB address and RABID information to manage many tunnels. The tunnel management table will be described, hereinafter, with reference to FIG. 5.

The user plane entity 220 includes a Down-Link Filter (DLPF) in the packet filter 222 to distinguish corresponding user data packet of a corresponding user equipment under its control.

The User data transmitted and received between the UPE 220 and the eNodeB 402 is transmitted in a form of a Radio Access Bearer (RAB) set. The RAB set 405 is user data corresponding to more than one RABID.

FIG. 5 shows a tunnel management table in accordance with an embodiment of the present invention.

As shown, the user plane entity is a subject and manager in creating and assigning a tunnel. The tunnel management table includes important information for transmitting user data using the logical tunnel between the UPE and the eNodeB.

Referring FIG. 5, the TEID can be sequentially assigned up to the maximum number of tunnels, using serial numbers [0], [1], . . . , [M], where M is the maximum number of tunnels. The tunnel management table formed according to each TEID includes state information about the tunnel, eNodeB address, RABID, RBID, and service type information.

The state information presents the state of the corresponding tunnel as being active or null.

The eNodeB address presents the address of a counterpart eNodeB of the corresponding tunnel. There is a final destination, which is a user equipment, in the eNodeB coverage at the address.

The RABID is an RABID corresponding to the TEID, and more than one RABID may be included. The RBID is an RBID mapped to the RABID in one to one.

The service type information indicates whether the user data of the corresponding tunnel is unicast data or multicast data.

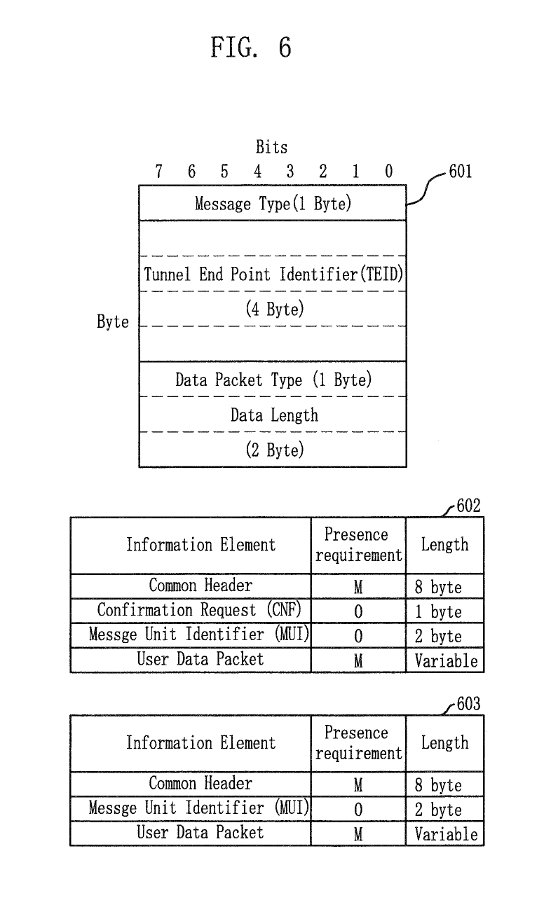

FIG. 6 illustrates a format of a protocol message for transmitting user data between eNodeB and UPE using the tunnel in accordance with an embodiment of the present invention.

Referring to FIG. 6, protocol messages between the eNodeB and the UPE include down-link protocol messages (DL_UNIT_DATA) 602 transmitted from the UPE to the eNodeB and up-link protocol messages (UL_UNIT_DATA) 603 transmitted from eNodeB to UPE.

A down-link protocol message (DL_UNIT_DATA) 602 includes an 8-byte common header, a 1-byte confirmation request (CNF), a 2-byte message unit identifier (MUI), and a user data packet of a variable length. The common header and the user data packet are essential parameters.

The confirmation request and the message unit identifier are control data transmitted and received between the PDCP of UPE and the RLC of eNodeB, and they are optional parameters transmitted upon a demand. The confirmation request and the message unit identifier are transmitted optionally according to the value of the data packet type of the common header 601 and when the data packet type is in an AM mode, the CNF and MUI should be included and transmitted.

The up-link protocol message (UL_UNIT_DATA) 603 includes a 8-byte common header, a 2-byte message unit identifier and a user data packet of a variable length.

The common header and the user data packet are essential parameters, and the message unit identifier is an optional parameter.

The common header commonly included in the down-link protocol message

(DL_UNIT_DATA) 602 and the up-link protocol message (UL_UNIT_DAT) 603 includes 1-byte message type information, a 4-byte TEID, 1-byte data packet type information and the data length of a payload.

The data packet type information is the type of data transmitted and received between the PDCP and the radio link control, and it includes an unacknowledged mode (UM), an acknowledged mode (AM), a transparent mode (TM), and AM_ACK.

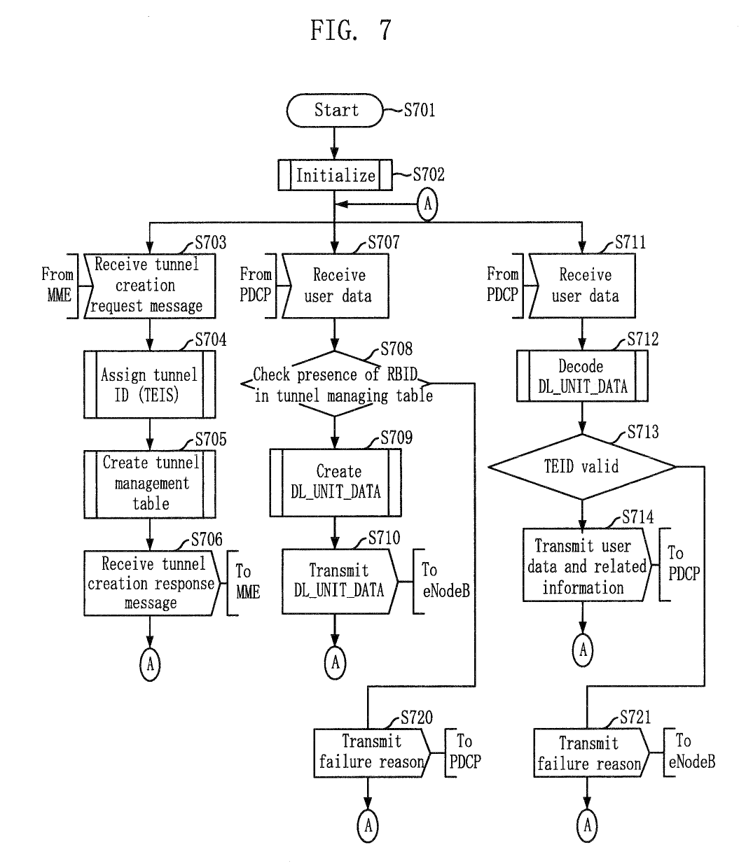

FIG. 7 is a flowchart describing a process of user data transmission between eNodeB and UPE using the tunnel in accordance with an embodiment of the present invention.

First, a user plane entity initializes a tunnel management table at step S702.

Next, when the tunnel creation request message is transmitted from a mobility management entity 703, a TEID of a tunnel corresponding to a received tunnel creation request is assigned at step S704, and a tunnel management table is created corresponding to the assigned TEID. At step S706, the tunnel creation acknowledgement message is transmitted to the MME.

According to the procedure, when the user data transmission request is received from PDCP or eNodeB in the state that the TEID is assigned and the tunnel management table is not created (which means a tunnel is not created), it is abandoned.

When the tunnel is created and a down-link user data are received at step S707, it is checked whether the TEID corresponding to RBID received from the PDCP along with the user data is on the tunnel management table at step S708.

When there is a TEID and the tunnel state is active, a down-link protocol message (DL_UNIT_DTA) is created by coding the user data at step S709 and transmitted to the eNodeB at step S710.

When there is no TEID, a PDCP failure cause is transmitted to the PDCP and the user data are abandoned at step S720.

When the tunnel is created and an up-link user data are received from eNodeB at step S711, an up-link protocol message (UL_UNIT_DATA) is decoded and the tunnel state of the tunnel management table is checked for validity of the received TEID at step S713.

As checked, when the tunnel state of the received TEID is idle, which is not valid, a transmission failure cause is transmitted to the eNodeB 721.

The method of the present invention described above may be realized as a program and stored in computer-readable recording media, such as CD-ROM, RAM, ROM, floppy disks, hard disks, magneto-optical disks, and the like. Since the process can be easily implemented by those of ordinary skill in the art to which the present invention pertains, it will not described in detail herein.

The present application contains subject matter related to Korean Patent Application No. 2006-0095815, filed in the Korean Intellectual Property Office on Sep. 29, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for transmitting user data in a mobile communication system, comprising the steps of:
a) assigning a tunnel identifier (ID);
b) creating a tunnel management table according to the tunnel ID;
c) receiving downlink user data;
d) creating a down-link protocol message corresponding to the down-link user data based on the tunnel ID; and
e) transmitting the down-link protocol message.

2. The method of claim 1, wherein the tunnel management table includes:
the tunnel ID; and
base station address information to which the user data are transmitted.

3. The method of claim 2, wherein the tunnel management table further includes:
state information indicating a utility state of a tunnel.

4. The method of claim 3, wherein the tunnel management table further includes:
a Radio Access Bearer ID (RABID) mapped with the tunnel ID; and
a Radio Bearer ID (RBID) mapped with the RABID.

5. The method of claim 4, wherein the tunnel management table further includes:
information indicating whether the user data of a corresponding tunnel are unicast data or multicast data.

6. The method of claim 1, wherein the down-link protocol message includes:
a header; and
a packet of the down-link user data, and
the header includes:
the tunnel ID; and
data packet type.

7. The method of claim 6, wherein the data packet type is one among an unacknowledged mode (UM), an acknowledged mode (AM) and a transparent mode (TM).

8. The method of claim 6, wherein the header further includes:
a message type of a message including the header; and
a data length of payload.

9. The method of claim 6, wherein the down-link protocol message further includes:
a confirmation request (CNF); and
a message unit identifier (MUI).

10. The method of claim 1, wherein a tunnel ID is assigned according to a tunnel creation request message transmitted from a mobility management entity (MME) in the tunnel ID assignment step a).

11. A method for transmitting user data in a mobile communication system, comprising the steps of:
a) assigning a tunnel ID;
b) creating a tunnel management table according to the tunnel ID;
c) receiving up-link user data from a base station;
d) creating an up-link protocol message corresponding to the up-link user data based on the tunnel ID; and
e) transmitting the up-link protocol message.

12. The method of claim 11, wherein the tunnel management table includes;
the tunnel ID;
state information indicating a state of a tunnel; and
base station address information indicating an address of the base station.

13. The method of claim 12, wherein the tunnel management table further includes:
a RABID mapped with the tunnel ID; and
a RBID mapped with the RABID.

14. The method of claim 13, wherein the tunnel management table includes:
information indicating whether the user data of a corresponding tunnel are unicast data or multicast data.

15. The method of claim 11, wherein the up-link protocol message includes:
a header;
a packet of the up-link user data, and
the header includes:
the tunnel ID; and
data packet type.

16. The method of claim 15, wherein the data packet type is one among an unacknowledged mode (UM), an acknowledged mode (AM), and a transparent mode (TM).

17. The method of claim 16, wherein the header includes:
a message type of a message including the header; and
a data length of payload.

18. The method of claim 15, wherein the up-link protocol message further includes a message unit identifier (MUI).

19. An apparatus for transmitting and receiving user data to and from a base station in a mobile communication system, wherein the apparatus includes a mobility management entity (MME) for managing and controlling mobility of a user equipment and a user plane entity (UPE) for transmitting user data, the apparatus comprising:
a tunneling managing means for assigning a tunnel identifier (ID) corresponding to transmitted or received user data; and
a base station interfacing means for transmitting and receiving a protocol message to and from the base station through a tunnel identified by the tunnel ID, wherein the tunneling managing means and the base station interfacing means are disposed in the user plane entity.

20. The apparatus of claim 19, wherein the user plane entity further includes:
an MME interfacing means for data transmitting and receiving data to and from the MME;
a packet filtering means for selecting user data heading for a user equipment disposed in a corresponding base station among user data transmitted from an external network; and
a packet compression/release/encryption for performing compression, release, and encryption onto data packets.

21. The apparatus of claim 19, wherein the tunnel management table includes:
the tunnel ID;
state information indicating a state of a tunnel; and
base station address information indicating an address of the base station.

22. The apparatus of claim 21, wherein the tunnel management table further includes:
a RABID mapped with the tunnel ID; and
a RBID mapped with the RABID.
